(19) United States
(12) Patent Application Publication
(10) Pub. No.: US 2024/0066414 A1
(43) Pub. Date: Feb. 29, 2024

(54) INTERACTION METHOD, INTERACTION APPARATUS, ELECTRONIC DEVICE, AND READABLE STORAGE MEDIUM

(71) Applicant: NETEASE (HANGZHOU) NETWORK CO., LTD., Hangzhou, Zhejiang (CN)

(72) Inventor: Yuan XUE, Hangzhou, Zhejiang (CN)

(21) Appl. No.: 18/270,021

(22) PCT Filed: Feb. 23, 2022
(86) PCT No.: PCT/CN2022/077483

§ 371 Date: Jun. 28, 2023

(30) Foreign Application Priority Data
Jun. 7, 2021 (CN) 202110633657.1

(51) Int. Cl. A63F 13/87; A63F 13/533; A63F 13/55

(52) U.S. Cl. CPC A63F 13/87; A63F 13/533; A63F 13/55

(57) ABSTRACT

The present disclosure provides an interaction method, an apparatus, an electronic device and a readable storage medium, where a response is given to evaluation information sent by a first user in a game for a second user, and when it is determined that interference information disturbing the second user exists in the evaluation information, response effects of the evaluation information on a first virtual character controlled by the first user and/or a second virtual character controlled by the second user are determined; game performance parameters of the first virtual character and/or the second virtual character are adjusted according to the determined response effects.

### CROSS-REFERENCE TO RELATED APPLICATIONS

This application is the U.S. National Phase application of the PCT International Application No. PCT/CN2022/077483, filed on Feb. 23, 2022, which is based upon and claims priority to Chinese Patent Application No. 202110633657.1, entitled “Interaction Method and Apparatus, Electronic Device and Readable Storage Medium”, filed on Jun. 7, 2021, the entire contents of both of which are incorporated herein by reference for all purposes.

### TECHNICAL FIELD

The present disclosure relates to the field of game control technologies, and particularly to an interaction method, an interaction apparatus, an electronic device, and a readable storage medium.

### BACKGROUND

In recent years, with gradual enrichment of people's spare time life, more and more games become familiar to people. More and more people choose to kill leisure time by playing games, and accordingly, types of games increase gradually. In the course of a fight game, in order to increase a winning speed and meanwhile apply a psychological pressure to an opponent, a winner usually mock the opponent, for example, sends sarcastic sentence, a sarcastic expression, or the like, to the opponent; such mocking does not really affect the opponent in nature and can only serve to stimulate an emotion of the opponent, and therefore, the progress of the game is not affected, and the course of the game is boring.

### SUMMARY

The present disclosure provides an interaction method and a readable storage medium, in which evaluation information of a user may have corresponding response effects on two fight parties.

A first aspect of the present disclosure provides an interaction method, including: in response to an evaluation information sent by a first user in a game for a second user, determining whether the evaluation information comprises an interference information disturbing the second user; in response to determining that the evaluation information comprises an interference information that disturbs the second user, determining a response effect of the evaluation information on a first virtual character controlled by the first user or a second virtual character controlled by the second user; and adjusting game performance parameters of the first virtual character or the second virtual character according to the response effect.

A second aspect of the present disclosure provides an interaction method, including: responding to an evaluation information sent by a first user in a game, and determining whether a target word exists in the evaluation information; and in response to determining that the target word exists, controlling a target virtual character to release a prompt animation corresponding to the evaluation information, where the target virtual character is a first virtual character controlled by a first user or a second virtual character controlled by a second user associated with the target word.

A third aspect of the present disclosure provides a non-transitory computer-readable storage medium having stored thereon instructions that, when executed by a processor of an electronic device, cause the electronic device to perform operations of an interaction method, the interaction method comprising steps of: in response to an evaluation information sent by a first user in a game for a second user, determining whether the evaluation information comprises an interference information disturbing the second user; in response to determining that the evaluation information comprises an interference information that disturbs the second user, determining a response effect of the evaluation information on a first virtual character controlled by the first user or a second virtual character controlled by the second user; and adjusting game performance parameters of the first virtual character or the second virtual character according to the response effect.

### BRIEF DESCRIPTION OF DRAWINGS

To describe the technical solutions in the embodiments of the present disclosure more clearly, the following briefly describes the accompanying drawings required in the embodiments. It should be understood that the following accompanying drawings show merely some embodiments of the present disclosure and therefore should not be considered as limiting the scope, and a person of ordinary skill in the art may still derive other related drawings from these accompanying drawings without creative efforts.

FIG. 1 is a flow chart of an interaction method provided in one of the embodiments of the present disclosure;

FIG. 2 is a schematic flow chart of a response effect determination mode provided in one of the embodiments of the present disclosure;

FIG. 3 is a schematic flow chart of an interference information determination mode provided in one of the embodiments of the present disclosure;

FIG. 4 is a schematic flow chart of a second user determination mode provided in one of the embodiments of the present disclosure;

FIG. 5 is a schematic flow chart of a second user determination mode provided in one of the embodiments of the present disclosure;

FIG. 6 is a flow chart of another interaction method provided in one of the embodiments of the present disclosure;

FIG. 7 is a schematic structural diagram of an interaction apparatus provided in one of the embodiments of the present disclosure;

FIG. 8 is a schematic structural diagram of an interaction apparatus provided in one of the embodiments of the present disclosure;

FIG. 9 is a schematic structural diagram of another interaction apparatus provided in one of the embodiments of the present disclosure; and

FIG. 10 is a schematic structural diagram of an electronic device provided in one of the embodiments of the present disclosure.

### DETAILED DESCRIPTION

To make the objectives, technical solutions and advantages of the embodiments of the present disclosure clearer, the technical solutions in the embodiments of the present disclosure are clearly and completely described with reference to the accompanying drawings in the embodiments of the present disclosure, and apparently, the described embodiments are not all but only a part of the embodiments of the present disclosure. Generally, the components of the embodiments of the present disclosure described and illustrated in the drawings herein may be arranged and designed in a variety of different configurations. Accordingly, the following detailed description of the embodiments of the present disclosure provided in the drawings is not intended to limit the scope of protection of the present disclosure, but only represents selected embodiments of the present disclosure. All other embodiments obtained by those skilled in the art based on the embodiments of the present disclosure without creative efforts shall fall within the protection scope of the present disclosure.

Research shows that currently, in a game fight process, two fight parties usually have two interaction modes: in a first mode, there is an interaction (for example, fight) of virtual characters controlled by the two fight parties in a virtual game scenario, and specifically, it may be an attack skill released by a skill releasing key or preset combination keys for attacking the virtual character controlled by the opponent; in a second mode, during the process of the interaction of the virtual characters controlled by the two fight parties, the two fight parties input evaluation information for evaluating the opponents by input devices (such as keyboards or touch keys on screens), for example, select corresponding expressions, sentences, or the like, for evaluating the opponents by mouse, or input text information for evaluating the opponents by keyboards, or input voice information for communicating with the opponents by voice input devices, such as microphones, or the like.

Compared with the first interaction mode, in the second interaction mode, the evaluation information, such as text, sentences, or the like, is sent in a simpler manner, but the evaluation information is often ignored by players, since players may not receive any response after sending the evaluation information, therefore players may lose interest in the second interaction mode and gradually abandon the second interaction mode.

Based on this, an embodiment of the present disclosure provides an interaction method in which a response may be given to evaluation information sent by a first user for a second user, and when interference information disturbing the second user exists in the evaluation information, response effects of the evaluation information on a first virtual character controlled by the first user and/or a second virtual character controlled by the second user are determined, so as to restrict a situation that the two fight parties send the evaluation information without restraint, and on the premise that the interaction modes between the two fight parties are increased, an effect of purifying the network environment may also be achieved.

The interaction method according to an embodiment of the present disclosure may be run in a terminal device used by the first user, or a terminal device used by the second user, or a background server. For example, in the following description, the above-mentioned interaction method is run in a terminal device (hereinafter, referred to as a terminal).

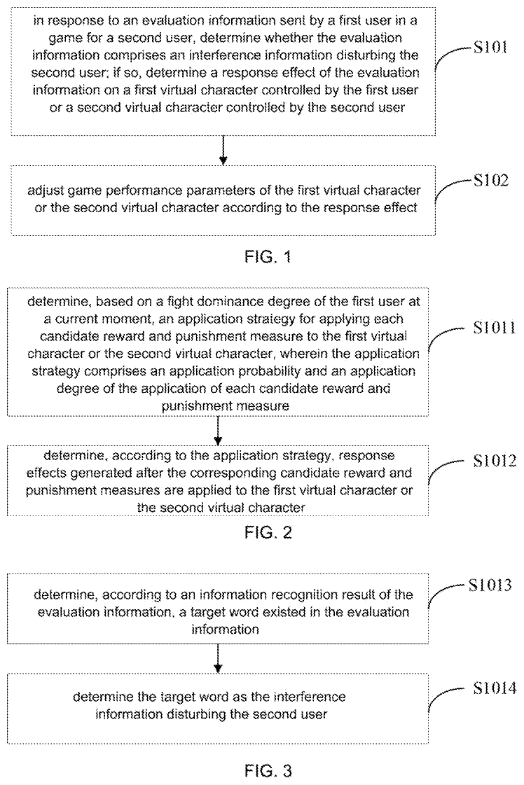

Reference is made to FIG. 1 which is a flow chart of an interaction method according to one of the embodiments of the present disclosure. As shown in FIG. 1, the interaction method according to the embodiment of the present disclosure includes:
S101: responding to evaluation information sent by a first user in a game for a second user, and judging whether interference information disturbing the second user exists in the evaluation information; if yes, determining response effects of the evaluation information on a first virtual character controlled by the first user and/or a second virtual character controlled by the second user; and
S102: adjusting game performance parameters of the first virtual character and/or the second virtual character respectively according to the response effects.

A graphical user interface is an interface for displaying a game screen on a display screen of the terminal. A game scenario is a virtual game space which carries a virtual character (or called a virtual character model) controlled by a user in the process of playing a game by the user, the virtual character may move, release skills and perform other actions in the game scenario according to control of an operation instruction issued to the terminal by the user, and the game scenario may include any one or more of the following elements: game background elements, game virtual character elements, game item elements, or the like, and content displayed by the graphical user interface in the present disclosure may include part of the game scenario or the whole game scenario.

The game screen refers to a partial screen in a virtual world observed at a specified viewing angle (for example, the viewing angle is based on the eye of the target virtual character model controlled by the user), and the partial screen is presented on the graphical user interface. The content displayed in graphical user interface is the game screen which can be seen by eyes.

The game scenarios refer to use scenarios involved in an execution process of the game by the user, and virtual character models (such as other virtual character models and a target virtual character model) controlled by different users may exist in the use scenarios. Common game scenarios are fight scenarios, and the fight scenarios refer to scenarios in which at least two virtual character models may interact (for example, duel). For example, a first user controls a first virtual character to attack a second virtual character controlled by a second user.

In the present disclosure, the response to the evaluation information sent by the first user in the game for the second user may refer to a response to the evaluation information sent by the first user for the second user in a game fight process; here, the game fight process refers to a process in which the virtual character controlled by any user interacts with the virtual characters controlled by other users, for example, a process in which, during execution of the game, the own virtual character is controlled to find the virtual character of the opponent, and a process in which, after the virtual character of the opponent is found, the own virtual character and the virtual character controlled by the opponent attack each other; it should be noted here that the game in the present disclosure does not include a process in which the user selects the virtual character.

Specifically, the first user may send the evaluation information to the second user by touching an evaluation information sending key with a finger, a mouse, or the like, or by preset combination keys in a keyboard, for example, keys of ctrl, alt, a, or the like, in the keyboard, and it should be noted that the preset keys may be manually set according to user requirements.

The evaluation information refers to information used by the first user when evaluating the second user or the second virtual character controlled by the second user in a running process of the game, and specifically may be information, such as expressions, pictures, text, voices, or the like; it should be noted that content contained in the evaluation information may have positive evaluation content or negative evaluation content, and it is not particularly limited here.

The interference information refers to information disturbing psychology or operation of the user, and in general, the interference information may cause the user to have a misoperation or operation mistake, and in severe cases, the interference information may cause the weak party in the game to lose the game in a current round.

The response effects refer to effects of the evaluation information on the first virtual character controlled by the first user and/or the second virtual character controlled by the second user determined in response to the evaluation information sent by the first user for the second user, for example, an increase of health point of the first virtual character, a decrease of attack power of the first virtual character, an increase of health point of the second virtual character, or the like.

The game performance parameters may be parameters involved in the fight process or the interaction process, such as health point, attack power, defense power, skill damage value, skill CD time, or the like, of the virtual character.

In step S101, during the running process of the game, when the evaluation information sent by the first user for the second user is received, the response is given to the evaluation information sent by the first user for the second user, and whether the interference information disturbing the second user exists in the evaluation information sent by the first user is judged.

If the interference information exists, the response effects of the evaluation information on the first virtual character controlled by the first user and/or the second virtual character controlled by the second user are determined respectively; it should be noted that the evaluation information may have response effects on both the first virtual character and the second virtual character, or have a response effect on only one of the first virtual character and the second virtual character, for example, an increase of the health point of the second virtual character controlled by the second user, and a decrease of the attack power of the first virtual character controlled by the first user, or, an increase of the defense power of the second virtual character, or, an increase of the skill damage value of the first virtual character, or the like.

It should be noted that the input evaluation information has two types, in the first type it is characters input by the first user in a specific region of the graphical user interface with an input device, such as a keyboard, a mouse, or the like, and in the second type it is voice information input by the first user by a voice input device, such as a microphone, an earphone, or the like.

Here, the characters include all input information which may be converted into characters, such as text, sentences, pictures, expressions, or the like, which are input by the first user; the voice information is information, such as music, sentences, or the like, input by the first user using any voice input device.

As an example, a case is described in which the evaluation information is a “ridicule expression”, and the first user issues an instruction of sending the evaluation information to the second user using a mouse; the first user selects the ridicule expression to be sent to the second user from an expression selection field, and issues the evaluation information sending instruction by touching a sending button displayed on the graphical user interface with the mouse, and at this point, the evaluation information sent by the first user may be recognized to be the ridicule expression, and since the ridicule expression is sarcastic information, the evaluation information sent by the first user to the second user may be confirmed to have interference information at this point, and further, the response effects of the evaluation information, i.e., the ridicule expression, on the first virtual character controlled by the first user and/or the second virtual character controlled by the second user are determined.

As an example, a case is described in which the evaluation information includes a sarcastic sentence, and the first user inputs the sarcastic sentence and issues an instruction of sending the evaluation information by a keyboard; the first user inputs the sarcastic sentence to be sent to the second user in a sentence input box displayed by the graphical user interface using the keyboard, and issues the evaluation information sending instruction by touching the “Enter” key in the keyboard, and at this point, the evaluation information sent by the first user may be recognized to have the sarcastic sentence, the sarcastic sentence present in the evaluation information is further analyzed to determine a sarcastic degree of the sarcastic sentence, and then, the response effects on the first virtual character controlled by the first user and/or the second virtual character controlled by the second user are determined according to the sarcastic degree.

It should be noted that the sarcastic degree refers to a degree of insult to the second user by the sarcastic sentence sent by the first user to the second user, and specifically, it may be determined by counting an occurrence number, an occurrence frequency and a proportion of the sarcastic words, or the like, in the sarcastic sentence; here, the sarcastic words may be preset, and when determining the occurrence number of the sarcastic words in the sarcastic sentence, only words in the sarcastic sentence are required to be compared with the preset sarcastic words.

As an example, it is assumed that the first user sends evaluation information to the second user twice, the first sent evaluation information includes 3 sarcastic words, the second sent evaluation information includes 4 sarcastic words, and the second evaluation information has a deeper sarcastic degree than the first evaluation information in a case where a number of characters of the evaluation information are the same; in a case where the number of the characters of the evaluation information are different, the occurrence frequency of the sarcastic words may be calculated according to the number of the characters of the evaluation information as well as a number of characters of the sarcastic words; for example, 20 characters are included in the second evaluation information, the sarcastic words have 8 characters, and then, the occurrence frequency of the sarcastic words may be 8/20×100%=40%; it should be noted that in the embodiment of the present disclosure, the occurrence frequency of the sarcastic words in the evaluation information is determined by calculating the ratio of the number of the characters of the sarcastic words to the total number of the characters of the evaluation information, and in other embodiments, other calculation methods may be adopted, such as a proportion of a number of words in the evaluation information, or the like.

In addition, when both words and expressions are included in the evaluation information, the sarcastic degree of the evaluation information may be calculated after the expressions are converted into words; or, the sarcastic degree of the expressions and the sarcastic degree of the sarcastic words may be calculated respectively, and then the sarcastic degree of the evaluation information is calculated by summing, averaging, or the like; or, the sarcastic degree of the evaluation information may be calculated after the words and the expressions are converted into characters.

In step S102, the game performance parameters of the first virtual character controlled by the first user and/or the game performance parameters of the second virtual character controlled by the second user are adjusted according to the determined response effects respectively.

Here, the game performance parameters may be a health point, an attack power, a defense power, a skill damage value, a skill CD time, and other parameters of the virtual character.

Specifically, the health point of the first virtual character and/or the second virtual character may be increased or decreased according to the response effects; the attack power of the first virtual character and/or the second virtual character during the next attack on other virtual characters may be increased or decreased according to the response effects.

In the present disclosure, in step S101 and step S102, for the response to the evaluation information sent by the first user in the game fight process for the second user, when the interference information disturbing the second user exists in the evaluation information, the response effects of the evaluation information on the first virtual character and/or the second virtual character are determined according to a degree of disturbance of the evaluation information to the second user; the game performance parameters of the first virtual character and/or the second virtual character are adjusted according to the response effects, thereby increasing the interaction modes between the first user and the second user in the game process and improving uncertainty of the game process.

Reference is made to FIG. 2, which is a schematic flow chart of a response effect determination mode in an embodiment of the present disclosure. In the present disclosure, in order to make the generated response effect more reasonable, the response effect corresponding to the evaluation information may be determined according to a fight dominance degree of the first user, and specifically, step S101 further includes:

S1011: determining an application strategy for applying each candidate reward and punishment measure to the first virtual character and/or the second virtual character based on the fight dominance degree of the first user at a current moment, where the application strategy includes an application probability and an application degree of each candidate reward and punishment measure; and

S1012: determining, according to the application strategy, response effects generated after the corresponding candidate reward and punishment measures are applied to the first virtual character and/or the second virtual character.

In the present disclosure, the fight dominance degree refers to a probability that the first user wins in the game when the first user sends the evaluation information, and if the fight dominance degree of the first user is obvious when the first user sends the evaluation information to the second user, that is, the probability that the first user wins the current round of fight is high, a probability of a response effect generating a buff to the first user may be reduced; correspondingly, a probability of a response effect generating a debuff to the first user may be increased at this point.

On the contrary, if the fight dominance degree of the first user is not obvious when the first user sends the evaluation information to the second user, that is, a probability that the first user loses the current round of fight is high, the probability of the response effect generating a buff to the first user may be increased; correspondingly, the probability of the response effect generating a debuff to the first user may be reduced at this point.

During specific implementation, one or more candidate reward and punishment measures may be applied to the first virtual character and/or the second virtual character; for example, the candidate reward and punishment measures may be an increase of the health point of the virtual character, a decrease of the health point of the virtual character, an increase of the attack power of the virtual character, a decrease of the attack power of the virtual character, or the like.

The application strategy includes an application degree and an application probability when the candidate reward and punishment measures are applied to the virtual character, and in a specific implementation process, the application probability and the application degree of each candidate reward and punishment measure may be adjusted according to the fight dominance degree of the first user; specifically, when the fight dominance degree of the first user is obvious, the probability of increasing the health point of the first virtual character controlled by the first user may be reduced, and at this point, compared with the second virtual character, even if the health point of the first virtual character is increased, an increase range of the health point is low; for example, in this case, when the health point of the virtual character is increased, the health point of the second virtual character is increase by 10 at a time, and the health point of the first virtual character can only be increased by 1 at a time; correspondingly, the probability of reducing the health point of the first virtual character controlled by the first user may be increased, and a reduction range of the health point may be increased; for example, in this case, when the health point of the virtual character is reduced, the health point of the second virtual character is reduced by 1 at a time, and the health point of the first virtual character is reduced by 10 at a time.

In step S1011, the fight dominance degree of the first user winning a fight at a current moment is acquired, and according to the fight dominance degree of the first user, the application strategy for applying each candidate reward and punishment measure to the first virtual character is determined, which includes the application probability and the application degree of each candidate reward and punishment measure applied to the first virtual character; meanwhile, the application strategy for applying each candidate reward and punishment measure to the second virtual character may be determined, which includes the application probability and the application degree of each candidate reward and punishment measure applied to the second virtual character.

In step S1012, according to the application strategies determined respectively for the first virtual character and/or the second virtual character, the response effect generated after the corresponding candidate reward and punishment measure is applied to the first virtual character and/or the corresponding candidate reward and punishment measure is applied to the second virtual character is determined.

Specifically, the response effects of the evaluation information on the first virtual character and/or the second virtual character are determined through steps S1012a to S1012c.

S1012a: determining, according to the application probability in the application strategy, a first reward and punishment measure applied to the first virtual character and/or a second reward and punishment measure applied to the second virtual character from the candidate reward and punishment measures;
S1012b: determining, based on the application degree in the application strategy, a first application effect of the first reward and punishment measure on the first virtual character and/or a second application effect of the second reward and punishment measure on the second virtual character; and
S1012c: determining the response effects based on the first application effect and/or the second application effect.

In the present disclosure, the first user sending the evaluation information has two fight conditions; firstly, the fight dominance degree of the first user is obvious; that is, the probability that the first user wins the current round of fight is higher, and at this point, the probability of applying a buffing candidate reward and punishment measure to the first user is lower than the probability of applying a debuffing candidate reward and punishment measure to the first user; on the contrary, at this point, the probability of applying the buffing candidate reward and punishment measure to the second user is higher than the probability of applying the debuffing candidate reward and punishment measure to the second user.

From the above, when the fight dominance degree indicates that a winning probability of the first user is greater than a losing probability of the first user, a probability that the first user obtains the buffing reward and punishment measure is negatively correlated with the winning probability of the first user, and a probability that the first user obtains the debuffing reward and punishment measure is positively correlated with the winning probability of the first user; for the second user, a probability of obtaining the buffing reward and punishment measure is positively correlated with the winning probability of the first user, and a probability of obtaining the debuffing reward and punishment measure is negatively correlated with the winning probability of the first user.

Secondly, the fight dominance degree of the first user is not obvious; that is, the probability that the first user loses the current round of fight is higher, and at this point, the probability of applying the buffing candidate reward and punishment measure to the first user is higher than the probability of applying the debuffing candidate reward and punishment measure to the first user; on the contrary, at this point, the probability of applying the buffing candidate reward and punishment measure to the second user is lower than the probability of applying the debuffing candidate reward and punishment measure to the second user.

From the above, when the fight dominance degree indicates that the winning probability of the first user is less than the losing probability of the first user, the probability that the first user obtains the buffing reward and punishment measure is positively correlated with the losing probability of the first user, and the probability that the first user obtains the debuffing reward and punishment measure is negatively correlated with the losing probability of the first user; for the second user, the probability of obtaining the buffing reward and punishment measure is negatively correlated with the losing probability of the first user, and the probability of obtaining the debuffing reward and punishment measure is positively correlated with the losing probability of the first user.

In step S1012a, the first reward and punishment measure applied to the first virtual character may be determined according to the application probability in the determined application strategy for applying each candidate reward and punishment measure to the first user; meanwhile, the second reward and punishment measure applied to the second virtual character may be determined according to the application probability in the determined application strategy for applying each candidate reward and punishment measure to the second user.

Here, the first reward and punishment measure applied to the first virtual character and the second reward and punishment measure applied to the second virtual character may be of the same type; for example, the first reward and punishment measure may be an increase of the health point of the virtual character, and the second reward and punishment measure may also be an increase of the health point of the virtual character.

However, in the case where the first reward and punishment measure and the second reward and punishment measure are of the same type, there is a difference between the degree of application of the first reward and punishment measure to the first virtual character and the degree of application of the second reward and punishment measure to the second virtual character; for example, the health point of the second virtual character is increased by 10 at a time, and the health point of the first virtual character is only increased by 1 at a time.

In addition, the first reward and punishment measure and the second reward and punishment measure may be null; that is, no reward and punishment measure is applied to the first virtual character and/or no reward and punishment measure is applied to the second virtual character.

In step S1012b, after the first reward and punishment measure applied to the first virtual character is determined, based on the application degree in the application strategy corresponding to the first reward and punishment measure, the first application effect generated after the first reward and punishment measure is applied to the first virtual character is determined; similarly, after the second reward and punishment measure applied to the second virtual character is determined, based on the application degree in the application strategy corresponding to the second reward and punishment measure, the second application effect generated after the second reward and punishment measure is applied to the second virtual character is determined.

During specific implementation, for example, the first reward and punishment measure is reduction of the health point of the virtual character and the second reward and punishment measure is an increase of the health point of the virtual character; when the reward and punishment measure applied to the first virtual character is determined to be the first reward and punishment measure and the reward and punishment measure applied to the second virtual character is determined to be the second reward and punishment measure, according to an indication of the application degree in the application strategy corresponding to the first reward and punishment measure, the first application effect is determined to be reduction of health point of the first virtual character by 10; correspondingly, according to an indication of the application degree in the application strategy corresponding to the second reward and punishment measure, the second application effect is determined to be an increase of health point of the second virtual character by 20.

In step S1012c, the response effects of the evaluation information on the first virtual character and/or the second virtual character are comprehensively determined based on the determined first application effect and second application effect.

Reference is made to FIG. 3, which is a schematic flow chart of an interference information determination mode in an embodiment of the present disclosure. In the present disclosure, in order to enable the evaluation information to generate the response effects on the first virtual character and/or the second virtual character more accurately, when the evaluation information is received, it is subjected to an information recognition to judge whether the interference information disturbing the second user exists in the evaluation information, and specifically, step S101 further includes step S1013 and step S1014, and the interference information disturbing the second user existing in the evaluation information is determined through step S1013 and step S1014:
S1013: determining a target word existing in the evaluation information according to an information recognition result of the evaluation information; and
S1014: determining the target word as the interference information disturbing the second user.

In the present disclosure, the target words may refer to insult words or words damaging the operation or psychology of the second user, and the target words often include information taunting the second user, for example, a ridicule expression.

In some special cases, the first user may taunt the second user by selecting a normal expression, and at this point, how to determine the target word accurately is particularly important in subsequent determination of the response effects of the evaluation information.

Here, when the evaluation information input by the first user is non-text information, such as an expression, or the like, the non-text information, such as the expression, or the like, may be converted into a character form, and then, the target word may be recognized on the premise of the characters.

When the evaluation information input by the first user is voice information, the voice information may be converted into text information, which is in turn converted into a character form, and then, the target word is recognized on the premise of the characters.

In step S1013, the evaluation information may be subjected to the information recognition, and the recognition result may be compared with a preset target word or a character corresponding to the target word, so as to judge whether the target word exists in the evaluation information; or, whether the target word exists in the evaluation information may be identified using a pre-trained model.

Or, feedback of the second user may be accepted; for example, after the first user sends the evaluation information to the second user, firstly, the evaluation information is recognized for the first time to determine candidate words which may be target words in the evaluation information; secondly, each candidate word is displayed in the graphical user interface of the second user in a sliding and/or popping mode, and meanwhile, prompt information for prompting the second user to select the target word is displayed, such that the second user can select the target word from the candidate words; if the second user selects the target word from the candidate words, the target word is determined to exist in the evaluation information; and if the second user does not select the target word or abandons the selection, the target word does not exist in the evaluation information.

Further, if the evaluation information is determined to have the target word after comparison with the preset target word, or the model identifies that the target word exists in the evaluation information, or the second user selects the target word from the candidate words, the target word is determined as disturbance, and the interference information disturbing the second user is determined to exist in the evaluation information.

When the candidate words are displayed in the graphical user interface of the second user, prompt information which prompts the second user to select the target word that has the response effects on the first user and/or the second user may also be displayed.

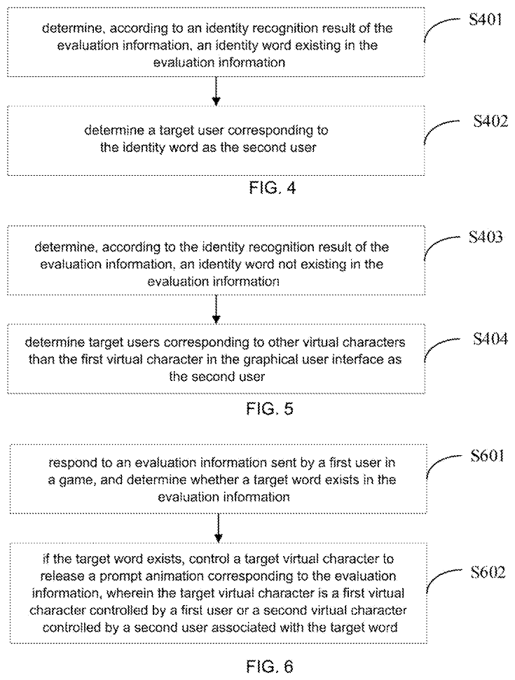

Reference is made to FIG. 4 which is a schematic flow chart of a second user determination mode in an embodiment of the present disclosure and FIG. 5 which is a schematic flow chart of a second user determination mode in an embodiment of the present disclosure. Further, as shown in FIGS. 4 and 5, when one or more second users other than the first user exist in the graphical user interface or in the game, the interaction method further includes steps S401 to S402 and steps S403 to S404:
S401: determining an identity word existing in the evaluation information according to an identity recognition result of the evaluation information;
S402: determining a target user corresponding to the identity word as the second user;
S403: determining an identity word not existing in the evaluation information according to the identity recognition result of the evaluation information; and
S404: determining target users corresponding to other virtual characters than the first virtual character in the graphical user interface as the second users.

In the present disclosure, the identity word may include a user name of a certain user, or be a character name of the virtual character controlled by a certain user, or be a related description of the virtual character; for example, the color of clothing, a virtual weapon held, or the like, of the virtual character are mentioned.

When the evaluation information sent by the first user is received, the evaluation information is subjected to an identity recognition, and whether the identity word of a certain user is mentioned in the evaluation information sent by the first user is determined according to the identity recognition result of the evaluation information, for example, the user name of a certain user is mentioned, or the character name of the virtual character controlled by a certain user is mentioned.

If the identity word is determined to exist in the evaluation information, the target user corresponding to the identity word is determined as the second user.

If the evaluation information is determined to have no identity word, it is indicated that the first user does not designate a certain user for evaluation. At this point, the target users corresponding to the virtual characters other than the first virtual character in the graphical user interface may be determined as the second users.

Here, one or more virtual characters may be displayed in the graphical user interface in addition to the first virtual character; when only one virtual character exists in the graphical user interface in addition to the first virtual character, the target user corresponding to the only one virtual character is determined as the second user no matter whether the evaluation information contains the identity word; when a plurality of virtual characters are displayed in the graphical user interface in addition to the first virtual character, if the evaluation information contains the identity word, the target user corresponding to the identity word is determined as the second user, and if the evaluation information does not contain the identity word, the target user corresponding to each virtual character other than the first virtual character is determined as the second user.

Furthermore, the first virtual character has a target skill corresponding to the interference information; the responding to evaluation information sent by a first user in a game for a second user includes: in response to a skill releasing operation for the target skill given by the first user to the first virtual character, control the first virtual character to release the target skill to the second virtual character, the releasing of the target skill cause the graphical user interface to display the evaluation information containing the interference information.

In this step, the first user may give an instruction of a skill releasing operation for attacking the second virtual character to the first virtual character in the game through a preset skill key and/or control, and here, the skills may include an attack-type skill and a sarcastic-type skill; the attack-type skill is refer to a skill for directly damaging the second virtual character, for example, a skill for reducing the health point, attack power, or the like, of the second virtual character; the sarcastic skill refers to a skill for controlling the first virtual character to output a particular virtual action, a particular expression, or particular dialog content, so as to damage psychology of the second user controlling the second virtual character, for example, a skill for controlling the first virtual character to make a provocative action or issue a haughty expression to the second virtual character or speak sarcastic-type words to the second virtual character.

When the first virtual character controlled by the first user has a target skill corresponding to the interference information disturbing the second user, in response to a skill releasing operation of the target skill issued by the first user to the first virtual character through touching a virtual key and/or control corresponding to the target skill, the first virtual character is controlled to release the target skill to the second virtual character, and here, since the target skill has the interference information, the first user may be affirmed to have an intent of taunting the second user; at this point, corresponding evaluation information including the interference information is generated for the target skill, and the evaluation information including the interference information is displayed in the graphical user interface.

Furthermore, in the present disclosure, in order to show a game screen to the user more vividly, after the determination of the response effect of the evaluation information, the interaction method further includes:
controlling the first virtual character and/or the second virtual character to take actions corresponding to the response effects; or, displaying prompt information corresponding to the evaluation information in a preset range of the first virtual character and/or the second virtual character; or, displaying prompt information corresponding to the evaluation information in a designated region of the graphical user interface in the form of text or animation; or playing a voice corresponding to the evaluation information.

In one of the implementations, after it is determined that the evaluation information produces the corresponding response effects on the first virtual character controlled by the first user and/or the second virtual character of the second user, the first virtual character and/or the second virtual character may be controlled to take the actions corresponding to the response effects; for example, the first virtual character and/or the second virtual character may be controlled to perform a preset dance, or the first virtual character throws a hit object to the second virtual character, and after hit by the hit object, the second virtual character may fall or go backwards to show the hitting.

In one of the implementations, the evaluation information is displayed in the preset range of the first virtual character and/or the preset range of the second virtual character in the form of corresponding prompt information, and when realized specifically, after the first user sends the evaluation information for the second user, the prompt information corresponding to the evaluation information is generated, a bubble dialog box is displayed in the preset range of the first virtual character controlled by the first user, and the prompt information corresponding to the evaluation information is displayed in the bubble dialog box to prompt the second user that the first user sends the evaluation information for the second user at this point, thereby avoiding that the second user looks away from an original sight range in order to check the evaluation of the first user for the second user, and thus misses an original good fight opportunity.

The preset range of the first virtual character may be a preset region with the first virtual character as a center and a preset length as a radius; the bubble dialog box is a region which is displayed in the preset region, has any size and is used for displaying the prompt information corresponding to the evaluation information, and the size of the bubble dialog box may be adjusted according to actual conditions, for example, according to a length of the prompt information or a display size of the font of the prompt information.

The evaluation information may also be displayed within the preset range of the second virtual character, and in specific implementation, after the first user sends the evaluation information for the second user, the prompt information corresponding to the evaluation information is generated, a bubble dialog box is displayed around the second virtual character controlled by the second user, and the prompt information corresponding to the evaluation information and information of the first user are displayed in the bubble dialog box to prompt the second user that the first user sends the evaluation information for the second user at this point, thereby avoiding that the second user looks away from an original sight range in order to check the evaluation of the first user for the second user, and thus misses an original good fight opportunity.

The preset range of the second virtual character may be a preset region with the second virtual character as a center and a preset length as a radius; the bubble dialog box is a region which is displayed in the preset region, has any size and is used for displaying the prompt information corresponding to the evaluation information, and the size of the bubble dialog box may be adjusted according to actual conditions. The information of the first user may be a nickname of the first user, or a character name of the first virtual character, or a related description of the first virtual character; for example, the color of clothing, a virtual weapon held, or the like, of the first virtual character are mentioned.

In one of the implementations, a designated region specially used for displaying the evaluation information may be pre-defined in the graphical user interface, and when the evaluation information sent by the first user for the second user is received, the prompt information corresponding to the evaluation information is displayed in the designated region in the form of text or animation, such that the second user may view the prompt information corresponding to the evaluation information of the first user in the designated region.

During specific implementation, the prompt information corresponding to the evaluation information may be displayed in a dialog display field on the right side of the graphical user interface in the form of text; specifically, the name of the first user, sending time of the evaluation information, and the prompt information corresponding to the evaluation information may be displayed in the dialog display field, and an information input field, an expression selection key, or the like, may also be set below the dialog display field. When a user wants to send information to another user, he may input the information in the information input field and send the same via a sending key.

The prompt information corresponding to the evaluation information may also be displayed in the dialog display field on the right side of the graphical user interface in the form of animation; for example, a virtual character is displayed in the dialog display field, and the virtual character “speaks”, to the second user, the prompt information corresponding to the evaluation information sent by the first user; here, “speak” may be in the form of a bubble dialog box, and specifically, reference may be made to the above-mentioned manner of displaying the prompt information in the bubble dialog box, which is not repeated herein.

In one of the implementations, when the evaluation information is voice information input by the first user, a voice corresponding to the evaluation information is directly played; when the evaluation information is non-voice information, in order to allow the second user to learn the evaluation information without viewing, the received evaluation information may be converted into a voice, and then, the evaluation information is played to the second user in the form of voice.

Furthermore, in order to allow the second user to selectively receive the evaluation information of the first user, the playing of the voice corresponding to the evaluation information may be controlled by:
step 1: displaying a voice playing control on the graphical user interface; and
step 2: in response to an operation of touching the voice playing control by the second user, playing the voice corresponding to the evaluation information.

In step 1, when the first user sends the evaluation information for the second user, the voice playing control is displayed in the graphical user interface to prompt the second user that the first user sends the evaluation information for the second user, and the second user may play the corresponding voice by touching the voice playing control. During specific implementation, a horn-shaped button, or the like, may be displayed over the head of the first virtual character and/or the second virtual character.

In step 2, if the second user touches the displayed voice playing control, the voice corresponding to the evaluation information is played to the second user in response to the operation of touching the voice playing control by the second user.

The touch operation in the present disclosure may include any one of the following operations: a touch operation performed by clicking the voice playing control displayed in the graphical user interface, a touch operation performed when the user presses a preset key, or the like. The preset key may be ctrl, alt, a, or the like, in a keyboard of the terminal, and the preset key may be manually set according to user requirements.

In the interaction method according to the embodiment of the present disclosure, in the game fight process, the response is given to the evaluation information sent by the first user for the second user, and when it is judged that the interference information disturbing the second user exists in the evaluation information, the response effects of the evaluation information on the first virtual character controlled by the first user and/or the second virtual character controlled by the second user are determined; the game performance parameters of the first virtual character and/or the second virtual character are adjusted according to the determined response effects. Thus, in the game fight process, the evaluation information between the users can also participate in the fight process, and further, the interaction modes of the two fight parties in the game fight process are increased, thus facilitating an improvement on flexibility of the game fight process.

Reference is made to FIG. 6, which is a flow chart of another interaction method provided in one of the embodiments of the present disclosure. As shown in FIG. 6, the interaction method according to the embodiment of the present disclosure includes:
S601: responding to evaluation information sent by a first user in a game, and determining whether a target word exists in the evaluation information; and
S602: if the target word exists, controlling a target virtual character to release a prompt animation corresponding to the evaluation information, where the target virtual character is a first virtual character controlled by a first user and/or a second virtual character controlled by a second user associated with the target word.

Generally, the evaluation information sent by the first user in a game fight process is displayed in a fixed region, for example, on the right side of a graphical user interface, or on the lower side of the graphical user interface, or is displayed in a hidden manner, and when the user wants to view comment information, the user is required to touch a corresponding icon to display the evaluation information; however, no matter which display manner is used, the user is required to look away from a fight region to the fixed region to view the evaluation information, which may cause the user to miss a good opportunity to attack the opponent or perform an erroneous operation.

Therefore, in order to prevent the user from looking away from the fight region, in the present disclosure, after the evaluation information sent by the first user is received, the target virtual character associated with the evaluation information may be controlled to release the prompt animation corresponding to the evaluation information, so as to achieve an effect of prompting the corresponding user.

The target virtual character playing the prompt animation may be the first virtual character controlled by the first user or the second virtual character controlled by the second user associated with the target word in the evaluation information; specifically, when the first user sends the evaluation information for the second user, it may be displayed as communication of the evaluation information to the second user by the first virtual character in the form of speaking; or when a target word, such as “beat”, or the like, exists in the evaluation information, the second virtual character of the second user who is beaten shows an action, such as falling, backward movement, or the like, so as to prompt the second user what evaluation information is sent to him by the first user. Here, the prompt animation released by the first virtual character and/or the second virtual character may be changed with a change of the target word.

During a specific implementation, in the game fight process, when the evaluation information sent by the first user is received, the response is given to the evaluation information sent by the first user, and the evaluation information is identified to determine whether the target word for prompting the second user associated with the evaluation information exists in the evaluation information.

If it is determined that the target word exists in the evaluation information, the target virtual character is controlled to release the prompt animation, for example, to perform an action, such as dancing, falling, backward movement, or the like, in a game.

In an implementation, when the evaluation information sent by the first user is received, the target virtual character may be determined according to the evaluation information by steps of:
determining a character identity word existing in the evaluation information according to a target recognition result of the evaluation information;
determining a target user corresponding to the character identity word as the second user;

and

determining the first virtual character controlled by the first user and the second virtual character controlled by the second user as the target virtual characters.

Here, the released prompt animations may be the same or different for the first virtual character and the second virtual character; for example, the prompt animation corresponding to the first virtual character is a throw of a hit object to the second virtual character; the prompt animation corresponding to the second virtual character is falling or backward movement after a hit by the thrown object.

In the present disclosure, in order to more vividly show the prompt animation to the user, the prompt animation corresponding to the evaluation information may be determined by steps of:
extracting the target word from the evaluation information;
determining a first prompt animation corresponding to the first virtual character and/or a second prompt animation corresponding to the second virtual character under the target word; and
determining the first prompt animation and/or the second prompt animation as the prompt animations corresponding to the evaluation information.

In the interaction method according to the embodiment of the present disclosure, the response is given to the evaluation information sent by the first user in the game, and whether the target word to be prompted exists in the evaluation information is judged; and if the target word exists, the target virtual character is controlled to release the prompt animation corresponding to the target word corresponding to the evaluation information, and here, the target virtual character for releasing the prompt animation may be the first virtual character controlled by the first user or the second virtual character controlled by the second user associated with the target word. Thus, in the game fight process, the evaluation information sent by the first user may be dynamically shown, and then, the user may be prevented from viewing the evaluation information in a fixed display region for the evaluation information, thereby simplifying operation complexity of the game and improving flexibility of the game.

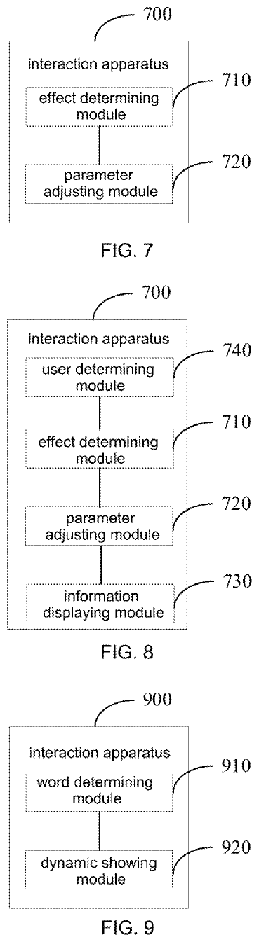

Reference is made to FIG. 7 which is a schematic structural diagram of an interaction apparatus according to one of the embodiments of the present disclosure and FIG. 8 which is a schematic structural diagram of an interaction apparatus according to one of the embodiments of the present disclosure. As shown in FIG. 7, the interaction apparatus 700 includes:
an effect determining module 710, configured to respond to evaluation information sent by a first user in a game for a second user, and judge whether interference information disturbing the second user exists in the evaluation information; if the target word exists, determine response effects of the evaluation information on a first virtual character controlled by the first user and/or a second virtual character controlled by the second user; and
a parameter adjusting module 720, configured to adjust game performance parameters of the first virtual character and/or the second virtual character according to the response effects respectively.

Further, as shown in FIG. 8, the interaction apparatus 700 further includes an information displaying module 730 configured to:
control the first virtual character and/or the second virtual character to take actions corresponding to the response effects;
or
display prompt information corresponding to the evaluation information in a preset range of the first virtual character and/or the second virtual character;
or
display prompt information corresponding to the evaluation information in a designated region of the graphical user interface in the form of text or animation;
or
play a voice corresponding to the evaluation information.

Further, as shown in FIG. 8, the interaction apparatus 700 further includes a user determining module 740 configured to:
determine an identity word existing in the evaluation information according to an identity recognition result of the evaluation information;
determine a target user corresponding to the identity word as the second user;
determine an identity word not existing in the evaluation information according to the identity recognition result of the evaluation information; and
determine target users corresponding to other virtual characters than the first virtual character in the graphical user interface as the second users.

Further, the evaluation information is characters input by the first user in a specific region of a graphical user interface, and/or the evaluation information is voice information input by the first user.

Further, the first virtual character has a target skill corresponding to the interference information; when responding to the evaluation information sent by the first user in the game for the second user, the effect determining module 710 is configured to:
in response to a skill releasing operation for the target skill given by the first user to the first virtual character, control the first virtual character to release the target skill to the second virtual character, where the releasing of the target skill causes the graphical user interface to display the evaluation information containing the interference information.

Further, when determining the response effects of the evaluation information on the first virtual character controlled by the first user and/or the second virtual character controlled by the second user, the effect determining module 710 is configured to:
determine an application strategy for applying each candidate reward and punishment measure to the first virtual character and/or the second virtual character based on a fight dominance degree of the first user at a current moment, where the application strategy includes an application probability and an application degree for applying each candidate reward and punishment measure; and
determine, according to the application strategy, response effects generated after the corresponding candidate reward and punishment measures are applied to the first virtual character and/or the second virtual character.

Further, when determining, according to the application strategy, the response effects generated after the corresponding candidate reward and punishment measures are applied to the first virtual character and/or the second virtual character, the effect determining module 710 is configured to:
determine, according to the application probability in the application strategy, a first reward and punishment measure applied to the first virtual character and/or a second reward and punishment measure applied to the second virtual character at this time from the candidate reward and punishment measures;
determine a first application effect of the first reward and punishment measure on the first virtual character and/or a second application effect of the second reward and punishment measure on the second virtual character based on the application degree in the application strategy; and
determine the response effects based on the first application effect and/or the second application effect.

Further, the effect determining module 710 is configured to determine the interference information present in the evaluation information and disturbing the second user by step of:
determining a target word present in the evaluation information according to an information recognition result of the evaluation information; and
determining the target word as the interference information disturbing the second user.

Further, when playing the voice corresponding to the evaluation information, the information displaying module 730 is configured to:
display a voice playing control on the graphical user interface; and
in response to a touching operation of the voice playing control by the second user, play the voice corresponding to the evaluation information.

In the interaction apparatus provided in the embodiment of the present disclosure, the response is given to the evaluation information sent by the first user in the game for the second user, and when it is judged that the interference information disturbing the second user exists in the evaluation information, the response effects of the evaluation information on the first virtual character controlled by the first user and/or the second virtual character controlled by the second user are determined; the game performance parameters of the first virtual character and/or the second virtual character are adjusted according to the determined response effects. Thus, in the game fight process, the evaluation information between the users can also be involved in the fight process, and further, the interaction modes of the two fight parties in the game fight process are increased, thus facilitating an improvement on flexibility of the game fight process.

Reference is made to FIG. 9, which is a schematic structural diagram of another interaction apparatus provided in on of the embodiments of the present disclosure. The interaction apparatus 900 includes:
a word determining module 910, configured to respond to evaluation information sent by a first user in a game, and determine whether a target word exists in the evaluation information; and
a dynamic showing module 920, configured to, if the target word exists, control a target virtual character to release a prompt animation corresponding to the evaluation information, where the target virtual character is a first virtual character controlled by a first user and/or a second virtual character controlled by a second user associated with the target word.

Further, the interaction apparatus 900 further includes a character determining module configured to:
determine a character identity word existing in the evaluation information according to a target recognition result of the evaluation information;
determine a target user corresponding to the character identity word as the second user; and
determine the first virtual character controlled by the first user and the second virtual character controlled by the second user as the target virtual characters.

Further, the interaction apparatus 900 further includes an animation determining module configured to:
extract the target word from the evaluation information;
determine a first prompt animation corresponding to the first virtual character and/or a second prompt animation corresponding to the second virtual character under the target word; and
determine the first prompt animation and/or the second prompt animation as the prompt animations corresponding to the evaluation information.

In the interaction apparatus according to the embodiment of the present disclosure, the response is given to the evaluation information sent by the first user in the game, and whether the target word to be prompted exists in the evaluation information is judged; and if the target word exists, the target virtual character is controlled to release the prompt animation corresponding to the evaluation information, and here, the target virtual character releasing the prompt animation may be the first virtual character controlled by the first user or the second virtual character controlled by the second user associated with the target word. Thus, in the game fight process, the evaluation information sent by the first user may be dynamically shown, and then, the user may be prevented from viewing the evaluation information in a fixed display region for the evaluation information, thereby simplifying operation complexity of the game and improving flexibility of the game.

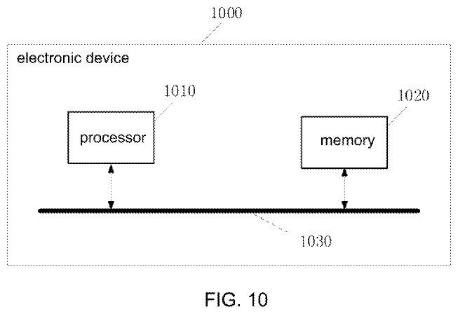

Reference is made to FIG. 10, which is a schematic structural diagram of an electronic device according to one of the embodiments of the present disclosure. As shown in FIG. 10, the electronic device 1000 includes a processor 1010, a memory 1020 and a bus 1030.

The memory 1020 stores machine-readable instructions executable by the processor 1010, the processor 1010 and the memory 1020 are communicated through the bus 1030 when the electronic device 1000 runs, the machine-readable instructions, when executed by the processor 1010, may perform the steps of the interaction methods according to the method embodiments shown in FIGS. 1 to 6, and for specific implementations, reference may be made to the method embodiments, which are not repeated herein.

An embodiment of the present disclosure further provides a computer-readable storage medium having a computer program stored thereon, and the computer program, when executed by a processor, may perform the steps of the interaction methods according to the method embodiments shown in FIGS. 1 to 6, and for specific implementations, reference may be made to the method embodiments, which are not repeated herein.

In the interaction method and apparatus, the electronic device and the readable storage medium according to the embodiments of the present disclosure, the response is given to the evaluation information sent by the first user in the game for the second user, and when it is determined that the interference information disturbing the second user exists in the evaluation information, the response effects of the evaluation information on the first virtual character controlled by the first user and/or the second virtual character controlled by the second user are determined; the game performance parameters of the first virtual character and/or the second virtual character are adjusted according to the determined response effects. Thus, in the game fight process, the evaluation information between the users can also be involved in the fight process, and further, the interaction modes of the two fight parties in the game fight process are increased, thus facilitating the improvement on the flexibility of the game fight process.

It may be clearly understood by those skilled in the art that, for the purpose of convenient and brief description, for a detailed working process of the foregoing system, apparatus, and unit, reference may be made to a corresponding process in the foregoing method embodiments, and details are not repeated herein.

In several embodiments provided in the present disclosure, it should be understood that the disclosed system, apparatus, and method may be implemented in other manners. The above described apparatus embodiment is only exemplary. For example, the unit division is only a logical function division, and there may be other division mode in actual implementation. For another example, a plurality of units or components may be combined or integrated into another system, or some features may be ignored or not performed. In addition, the shown or discussed mutual couplings or direct couplings or communication connections may be implemented through some communication interfaces, and indirect couplings or communication connections between the apparatuses or units may be implemented in electronic, mechanical or other forms.

The units described as separate parts may or may not be physically separate, and parts shown as units may or may not be physical units, that is, may be located in one position, or may be distributed on a plurality of network units. A part or all of the units may be selected according to an actual requirement to achieve the objectives of the solutions in the embodiments.

In addition, functional units in the embodiments of the present disclosure may be integrated into one processing unit, or each of the units may exist alone physically, or two or more units are integrated into one unit.

When the function is implemented in the form of a software functional unit and sold or used as an independent product, it may be stored in a non-volatile computer-readable storage medium executable by a processor. Based on such an understanding, the essential or the part contributing to the prior art of the technical solutions of the present disclosure, or a part of the technical solutions may be implemented in the form of a software product. The computer software product is stored in a storage medium and includes several instructions for instructing a computer device (which may be a personal computer, a server, or a network device) to perform all or a part of steps of the method described in the embodiment of the present disclosure. The foregoing storage medium includes: any medium that can store program codes, such as a USB flash disk, a mobile hard disk, a read-only memory (ROM), a random access memory (RAM), a magnetic disk, or an optical disk.

Finally, it should be noted that the above embodiments are only specific implementations of the present disclosure, which is used to illustrate the technical solutions of the present disclosure, but not to limit them, and the protection scope of the present disclosure is not limited thereto; although the present disclosure is described in detail with reference to the above embodiments, those ordinary skilled in the art should understand that any person skilled in the art still can modify technical solutions recited in the aforesaid embodiments or easily envisage changes or equivalently replace partial technical features therein within the technical scope of the present disclosure; these modifications, changes or substitutions do not make essence of corresponding technical solutions depart from the spirit and scope of the technical solutions of the embodiments of the present disclosure, and are intended to be covered by the protection scope of the present disclosure. Therefore, the protection scope of the present disclosure shall be subject to the protection scope of the claims.

1. An interaction method, comprising:
in response to an evaluation information sent by a first user in a game for a second user, determining whether the evaluation information comprises an interference information disturbing the second user;
in response to determining that the evaluation information comprises an interference information that disturbs the second user, determining a response effect of the evaluation information on a first virtual character controlled by the first user or a second virtual character controlled by the second user; and
adjusting game performance parameters of the first virtual character or the second virtual character according to the response effect respectively.

2. The interaction method according to claim 1, wherein the evaluation information comprises characters input by the first user in a specific region of a graphical user interface, or the evaluation information comprises a voice information input by the first user.

3. The interaction method according to claim 1, wherein the first virtual character has a target skill corresponding to the interference information; and
wherein responding to the evaluation information sent by the first user in the game for the second user further comprises:
in response to a skill releasing operation for the target skill given by the first user to the first virtual character, controlling the first virtual character to release the target skill to the second virtual character, and the releasing of the target skill cause the graphical user interface to display the evaluation information containing the interference information.

4. The interaction method according to claim 1, further comprising at least one of the following steps of:
controlling the first virtual character or the second virtual character to release actions corresponding to the response effect; or
displaying a prompt information corresponding to the evaluation information in a preset range of the first virtual character or the second virtual character; or
displaying a prompt information corresponding to the evaluation information in a designated region of the graphical user interface in a form of text or animation; or
playing a voice corresponding to the evaluation information.

5. The interaction method according to claim 4, wherein playing the voice corresponding to the evaluation information comprises:
displaying a voice playing control in the graphical user interface; and
in response to a touching operation of the voice playing control by the second user, playing the voice corresponding to the evaluation information.

6. The interaction method according to claim 1, wherein determining the response effect of the evaluation information on the first virtual character controlled by the first user or the second virtual character controlled by the second user comprises:
determining, based on a fight dominance degree of the first user at a current moment, an application strategy for applying each candidate reward and punishment measure to the first virtual character or the second virtual character, wherein the application strategy comprises an application probability and an application degree of the application of each candidate reward and punishment measure; and
determining, according to the application strategy, response effects generated after the corresponding candidate reward and punishment measures are applied to the first virtual character or the second virtual character.

7. The interaction method according to claim 6, wherein determining, according to the application strategy, the response effects generated after the corresponding candidate reward and punishment measures are applied to the first virtual character or the second virtual character comprises:
determining, according to the application probability in the application strategy, a first reward and punishment measure applied to the first virtual character or a second reward and punishment measure applied to the second virtual character at this time from the candidate reward and punishment measures;
determining, based on the application degree in the application strategy, a first application effect of the first reward and punishment measure on the first virtual character or a second application effect of the second reward and punishment measure on the second virtual character; and
determining the response effects based on the first application effect or the second application effect.

8. The interaction method according to claim 1, wherein the interaction method further comprises:
determining, according to an identity recognition result of the evaluation information, an identity word existing in the evaluation information;
determining a target user corresponding to the identity word as the second user;
determining, according to the identity recognition result of the evaluation information, an identity word not existing in the evaluation information; and
determining target users corresponding to other virtual characters than the first virtual character in the graphical user interface as the second users.

9. The interaction method according to claim 1, wherein the interference information disturbing the second user comprised in the evaluation information is determined by steps of:
determining, according to an information recognition result of the evaluation information, a target word existed in the evaluation information; and
determining the target word as the interference information disturbing the second user.

10. An interaction method, comprising:
responding to an evaluation information sent by a first user in a game, and determining whether a target word exists in the evaluation information; and
in response to determining that the target word exists, controlling a target virtual character to release a prompt animation corresponding to the evaluation information, wherein the target virtual character is a first virtual character controlled by a first user or a second virtual character controlled by a second user associated with the target word.

11-13. (canceled)

14. A non-transitory computer-readable storage medium having stored thereon instructions that, when executed by a processor of an electronic device, cause the electronic device to perform operations of an interaction method, the interaction method comprising steps of:
in response to an evaluation information sent by a first user in a game for a second user, determining whether the evaluation information comprises an interference information disturbing the second user;
in response to determining that the evaluation information comprises an interference information that disturbs the second user, determining a response effect of the evaluation information on a first virtual character controlled by the first user or a second virtual character controlled by the second user; and
adjusting game performance parameters of the first virtual character or the second virtual character according to the response effect.

15. The non-transitory computer-readable storage medium according to claim 14, wherein the first virtual character has a target skill corresponding to the interference information; and wherein responding to the evaluation information sent by the first user in the game for the second user further comprises:
in response to a skill releasing operation for the target skill given by the first user to the first virtual character, controlling the first virtual character to release the target skill to the second virtual character, and the releasing of the target skill cause the graphical user interface to display the evaluation information containing the interference information.

16. The non-transitory computer-readable storage medium according to claim 14, wherein the interaction method further comprising:
controlling the first virtual character or the second virtual character to release actions corresponding to the response effect; or
displaying a prompt information corresponding to the evaluation information in a preset range of the first virtual character or the second virtual character; or
displaying a prompt information corresponding to the evaluation information in a designated region of the graphical user interface in a form of text or animation; or
playing a voice corresponding to the evaluation information.

17. The non-transitory computer-readable storage medium according to claim 14, wherein determining the response effect of the evaluation information on the first virtual character controlled by the first user or the second virtual character controlled by the second user comprises:
determining, based on a fight dominance degree of the first user at a current moment, an application strategy for applying each candidate reward and punishment measure to the first virtual character or the second virtual character, wherein the application strategy comprises an application probability and an application degree of the application of each candidate reward and punishment measure; and
determining, according to the application strategy, response effects generated after the corresponding candidate reward and punishment measures are applied to the first virtual character or the second virtual character.

18. The non-transitory computer-readable storage medium according to claim 17, wherein determining, according to the application strategy, the response effects generated after the corresponding candidate reward and punishment measures are applied to the first virtual character or the second virtual character comprises:
determining, according to the application probability in the application strategy, a first reward and punishment measure applied to the first virtual character or a second reward and punishment measure applied to the second virtual character at this time from the candidate reward and punishment measures;
determining, based on the application degree in the application strategy, a first application effect of the first reward and punishment measure on the first virtual character or a second application effect of the second reward and punishment measure on the second virtual character; and
determining the response effects based on the first application effect or the second application effect.

19. The non-transitory computer-readable storage medium according to claim 14, wherein the interaction method further comprising:
determining, according to an identity recognition result of the evaluation information, an identity word existing in the evaluation information;
determining a target user corresponding to the identity word as the second user;
determining, according to the identity recognition result of the evaluation information, an identity word not existing in the evaluation information; and
determining target users corresponding to other virtual characters than the first virtual character in the graphical user interface as the second users.

20. The interaction method according to claim 1, wherein the evaluation information comprises a sarcastic sentence, the sarcastic sentence is analyzed to determine a sarcastic degree of the sarcastic sentence, and the response effect on the first virtual character controlled by the first user or the second virtual character controlled by the second user are determined according to the sarcastic degree.

21. The interaction method according to claim 1, wherein the evaluation information comprises both words and expressions, and a sarcastic degree of the evaluation information is calculated after the expressions are converted into words; or the sarcastic degree of the expressions and the sarcastic degree of the sarcastic words are calculated respectively, and the sarcastic degree of the evaluation information is calculated by summing, or averaging; or the sarcastic degree of the evaluation information is calculated after the words and the expressions are converted into characters.

22. The interaction method according to claim 6, wherein the candidate reward and punishment measure comprises an increase of the health point of a virtual character, a decrease of the health point of the virtual character, an increase of the attack power of the virtual character, or a decrease of the attack power of the virtual character.

23. The interaction method according to claim 7, further comprising:
in response to determining that the fight dominance degree of the first user is obvious, reducing a probability of applying a buffing candidate reward and punishment measure to the first user, and increasing a probability of applying a debuffing candidate reward and punishment measure to the first user, wherein the probability of applying the buffing candidate reward and punishment measure to the first user is lower than the probability of applying the debuffing candidate reward and punishment measure to the first user.
